(19) United States
(12) Patent Application Publication
(10) Pub. No.: US 2018/0291307 A1
(43) Pub. Date: Oct. 11, 2018

(54) EXTRACTOR WITH DROP ZONE MIXING

(71) Applicant: Crown Iron Works Company, Roseville, MN (US)

(72) Inventors: George E. ANDERSON, Champlin, MN (US); Benjamin Wayne FLOAN, Andover, MN (US)

(21) Appl. No.: 15/750,629

(22) PCT Filed: Aug. 5, 2016
(86) PCT No.: PCT/US2016/045889

§ 371 Date: Feb. 6, 2018

Related U.S. Application Data
(60) Provisional application No. 62/202,480, filed on Aug. 7, 2015.

(51) Int. Cl. C11B 1/10; B01D 11/02

(52) U.S. Cl. CPC C11B 1/10; B01D 11/0203; B01D 11/0288; B01D 11/023

(57) ABSTRACT

An immersion extractor may have a housing that maintains a solvent pool in which solids material being processed is immersed during operation. One or more bed decks can be positioned inside of the housing to provide multiple extraction stages. In some examples, the bed decks are arranged to provide one bed deck positioned at a vertically elevated position relative to another bed deck, thereby providing a drop zone where the solids material passing through the machine drops from the vertically elevated bed deck to a lower bed deck. To increase contact between the solids material and surrounding solvent to improve extraction efficiency, the extractor may include mixing hardware that is configured to intermix the solids material with the solvent as solids material drops from the vertically elevated bed deck to the lower bed deck.

### RELATED APPLICATIONS

This application claims priority to U.S. Provisional Application No. 62/202,480, filed Aug. 7, 2015, the entire contents of which are incorporated herein by reference.

### TECHNICAL FIELD

This disclosure relates to solvent extraction and, more particularly, to liquid-solvent extractors.

### BACKGROUND

A variety of different industries use extractors to extract and recover liquid substances entrained within solids. For example, producers of oil from renewable organic sources use extractors to extract oil from oleaginous matter, such as soybeans, rapeseed, sunflower seed, peanuts, cottonseed, palm kernels, and corn germ. The oleaginous matter is contacted with an organic solvent within the extractor, causing the oil to be extracted from a surrounding cellular structure into the organic solvent. As another example, extractors are used to recover asphalt from shingles and other petroleum-based waste materials. Typically, the petroleum-based material is ground into small particles and then passed through an extractor to extract the asphalt from the solid material into a surrounding organic solvent.

Regardless of the application in which an extractor is used, manufacturers and operators of extractors are continuously looking for ways to improve the economic efficiency of their extractor operation. This can involve controlling the extractor to maximize the amount of extract recovered from a given feedstock while minimizing the amount of solvent lost during extraction and recovery. This can also involve operating the extractor harder by increasing the feedstock flow rate through the extractor. Unfortunately, attempts to increase feedstock flow rate through an extractor often result in a corresponding decrease in extract recovery. This can occur when the feedstock does not have sufficient residence time within the extractor and/or the increased feedstock volume inhibits proper intermixing between the extraction solvent and the feedstock.

### SUMMARY

In general, the present disclosure is directed to an immersion extractor that has a housing that maintains a solvent pool in which solids material being processed is immersed during operation. In some examples, multiple bed decks are arranged in the housing to provide surfaces along which the material being processed travels through the extractor and that defines different extraction stages. For example, the extractor may contain one bed deck positioned at a vertically elevated position relative to another bed deck, thereby defining a drop zone where the solids material passing through the extractor drops under the force of gravity from the vertically elevated bed deck to a lower bed deck. In some configurations, the extractor includes mixing hardware that is configured to intermix the solids material with the solvent as solids material drops from the vertically elevated bed deck to the lower bed deck. This can increase contact between the solids material and surrounding solvent to improve extraction efficiency.

In one example, an immersion extractor is described that includes a housing, a plurality of bed decks, and mixing hardware. The housing is configured to maintain a solvent pool in which a solids material being processed is immersed during operation of the extractor. The plurality of bed decks are positioned inside the housing and bed deck provides a surface along which the solids material is conveyed during operation of the extractor. The example specifies that at least one of the plurality of bed decks is positioned at a vertically elevated position relative to another of the plurality of bed decks so as to define a drop zone where the solids material drops from the vertically elevated bed deck to a lower bed deck. Further, the mixing hardware is configured to intermix the solids material with the solvent as solids material drops from the vertically elevated bed deck to the lower bed deck.

In another example, a method is described that includes conveying solids material to be processed through a solvent pool of an immersion extractor. The process of conveying the solids material through the solvent pool includes conveying the solids material along a plurality of bed decks that include one bed deck positioned at a vertically elevated position relative to another bed deck that defines a lower bed deck. The method also involves mixing solids material flowing from the vertically elevated bed deck toward the lower bed deck using mixing hardware.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a side view of an example extractor that can be used to process a continuous flow of solid material.

FIG. 2 is a partial side view of an example configuration of the extractor of FIG. 1 showing an example drop zone mixing hardware configuration.

### DETAILED DESCRIPTION

In general, the disclosure relates to liquid-solid countercurrent extraction processes that enable the extraction of one or more desired products from solid material flows. In some examples, an extractor conveys a continuous flow of material from its inlet to its outlet while a solvent is conveyed in a countercurrent direction from a solvent inlet to a solvent outlet. As the solvent is conveyed from its inlet to its outlet, the concentration of extracted liquid relative to solvent increases from a relatively small extract-to-solvent ratio to a comparatively large extract-to-solvent ratio. Similarly, as the solid material is conveyed in the opposing direction, the concentration of extract in the solid feedstock decreases from a comparatively high concentration at the inlet to a comparatively low concentration at the outlet. The amount of time the solid material remains in contact with the solvent within the extractor (which may also be referred to as residence time) can vary, for example depending on the material being processed and the operating characteristics of the extractor, although will typically be within the range of 15 minutes to 3 hours, such as from 1 hour to 2 hours.

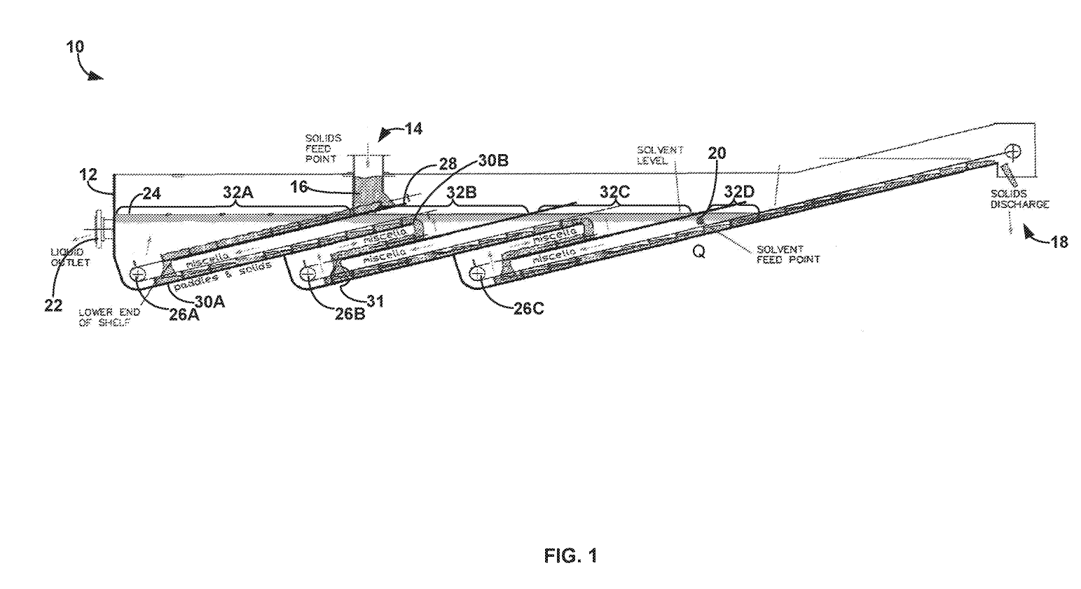

FIG. 1 is a side view of an example extractor 10 that can be used to process a continuous flow of solid material carrying one or more compounds desired to be extracted into a solvent. As shown in this example, extractor 10 includes a housing 12 containing one or more extraction stages through which a material being processed travels in a countercurrent direction with an extraction solvent. Housing 12 includes a feed inlet 14 configured to receive a continuous flow of solids material 16 carrying an extract to be extracted within extractor 10. Extractor 10 also includes a feed outlet 18 configured to discharge the solids material 16 after sonic or all of the extract has been extracted into solvent flowing through the extractor.

To provide a flow of solvent passing through extractor 10, housing 12 also includes a solvent inlet 20 that receives solvent devoid of extract or having a comparatively low concentration of extract. A solvent outlet 22 is provided on a generally opposite end of housing 12 to discharge solvent having passed through extractor 10. As solvent travels through housing 12 from inlet 20 to outlet 22, the solvent flows in a countercurrent direction from the flow of solids material 16 passing through the extractor. The solvent intermixes with solids material 16 within extractor 10, causing the extract carried by the solids material to transfer from the solids material to the solvent. Accordingly, in operation, solvent having a comparatively low concentration of extract enters at inlet 20 while solvent having in increased concentration of extract discharges at outlet 22. Likewise, fresh solids material 16 carrying extract enters at inlet 14 while processed solids material having a reduced concentration of extract is discharged at outlet 18. For example, in instances where solids material 16 is an oil-bearing material, solvent can extract oil out of the solids material forming a miscella (the solution of oil in the extraction solvent) that is discharged through outlet 22.

Extractor 10 can process any desired solids material 16 using any suitable solvent. Example types of solids material 16 that can be processed using extractor 10 include, but are not limited to, oleaginous matter, such as soybeans (and/or soy protein concentrate), rapeseed, sunflower seed, peanuts, cottonseed, palm kernels, and corn germ; oil-bearing seeds and fruits; asphalt-containing materials (e.g., asphalt-containing roofing shingles that include an aggregate material such as crushed mineral rock, asphalt, and a fiber reinforcing); stimulants (e.g., nicotine, caffeine); alfalfa; almond hulls; anchovy meals; bark; coffee beans and/or grounds, carrots; chicken parts; chlorophyll; diatomic pellets; fish meal; hops; oats; pine needles; tar sands; vanilla; and wood chips and/or pulp. Solvents that can be used for extraction of solids material 16 include, but are not limited to, acetone, hexane, toluene, isopropyl alcohol, ethanol, other alcohols, and water.

Extractor 10 can be operated as an immersion extractor in which a pool or reservoir of solvent 24 is maintained in housing 12 to provide a desired solvent level inside the extractor. In such applications, solids material 16 is immersed (e.g., submerged) in the pool of solvent 24 as it moves through extractor 10. In some examples, solids material 16 remains completely submerged in the pool of solvent 24 as it travels through extractor 10, e.g., except when adjacent inlet 14 and outlet 18. In other examples, solids material 16 travels above the pool of solvent 24 at different stages in extractor 10 before falling off the end of a conveyor and dropping back into the pool of solvent. As one example, extractor 10 may be implemented using a Model IV extractor commercially available from Crown iron Works Company of Minneapolis, Minn.

To contact solids material 16 with solvent inside of extractor 10, the extractor has one or more conveyors that convey the material in a countercurrent direction through the pool of solvent 24. In the configuration of FIG. 1, for instance, extractor 10 has three conveyors 26A, 26B, 26C that convey solids material 16 through the solvent pool 24 contained within housing 12. Solids material 16 can travel along decks or trays 28 positioned inside of extractor 10 to define a bed of material. Each bed deck 28 may define a receiving end 30A and a discharge end 30B. In operation, solids material 16 can drop onto the receiving end 30A of the bed deck 28 and then be conveyed along the bed deck by the conveyor until reaching the discharge end 30B. Upon reaching discharge end 30B, solids material 16 can drop off or fall over the terminal edge of the bed deck, for example, onto a lower bed deck.

The vertical distance separating the discharge end 30B of an upper bed deck 28 from a receiving end 30A of a lower bed deck 28 may provide a mixing or drop zone 32 through which solids material 16 travels. For example, solids material 16 dropping off the discharge end 30B of an upper bed deck 28 can mix and interact with solvent located between the upper bed deck and a lower bed deck in drop zone 31, e.g., as the solids material falls under the force of gravity toward the lower bed deck. A desired extract carried by the solids material 16 can be extracted into the solvent within this drop zone as the solids material intermixes with the solvent within the drop zone. Increasing the number bed decks 28 within extractor 10 and, correspondingly, the number of drop zones between bed decks, can increase the amount of extract recovered from a specific solids material 16 being processed on the extractor.

Extractor 10 can have any suitable number of bed decks 28 arranged in any desired orientation. In the example, of FIG. 1, extractor 10 is illustrated as having six bed decks 28, although the extractor can have fewer bed decks or more bed decks. In addition, in this example, bed decks 28 are arranged at an inclined angle such that the bed decks are alternatingly sloped downwardly and upwardly. Bed decks 28 may be arranged in series with adjacent bed decks being vertically and/or laterally offset from one another to provide adjacent flow pathways over which solids material 26 travels when passing through extractor 10. For example, bed decks 28 may be arranged in parallel to define a serpentine pathway along which solids material 16 is conveyed through pool of solvent 24 between inlet 14 and outlet 18. In operation, solids material 26 may travel along a downwardly sloped bed deck 28 before dropping onto an upwardly sloped lower bed deck, at which point the solids material reverses direction and travels laterally and vertically in an opposed direction from the direction of travel on the upper bed deck.

In the example of FIG. 1, solids material 16 enters extractor 10 via inlet 14 and falls onto a first downwardly sloped bed deck. Conveyor 26A moves solids material 16 from the receiving end of the first downwardly sloped bed deck to the discharge end of the first downwardly sloped bed deck, whereupon the solids material drops off of the deck through a first drop zone onto a first upwardly sloped bed deck. Conveyor 26A moves solids material 16 from the receiving end of this first upwardly sloped bed deck to the discharge end of this bed deck, whereupon the solids material drops off of the deck through a second drop zone onto a second downwardly sloped bed deck. Conveyor 26B moves solids material 16 from the receiving end of the second downwardly sloped bed deck to the discharge end of this bed deck, whereupon the solids material drops off of the deck through a third drop zone onto a second upwardly sloped bed deck. Conveyor 26B moves solids material 16 from the receiving end of this second upwardly sloped bed deck to the discharge end of the bed deck, whereupon the solids material drops off of the deck through a third drop zone onto a third downwardly sloped bed deck. Conveyor 26C moves solids material 16 from the receiving end of the third downwardly sloped bed deck to the discharge end of this bed deck, whereupon the solids material drops off of the deck through a fourth drop zone onto a third upwardly sloped bed deck. Finally, conveyor 26C moves solids material 16 along this final bed deck out of the solvent pool 26 and discharges the processed solids material via outlet 18.

In some examples, the pool of solvent 24 contained within housing 12 is divided into fluidly interconnected sub-pools, e.g., to provide different equilibrium extraction stages. For example, bed decks 28 may provide physical barriers that separate each sub-pool from each adjacent sub-pool and prevent solvent from flowing through the bed deck. In such examples, solvent may flow around the discharge end 30B of each bed deck rather than through the bed deck, allowing the solvent to flow in a countercurrent direction from solids material 16 through extractor 10. Other physical divider structures in addition to or in lieu of bed decks 28 can be used to separate the pool of solvent 24 in different sections.

In the example of FIG. 1, extractor 10 is illustrated as having four solvent pools 32A-32D. Each downwardly sloping bed deck 28 provides a barrier between adjacent pools with adjacent solvent pools being connected at the discharge end of a separating bed deck. In operation, each solvent pool of pools 32A-32D may have a different average extract-to-solvent concentration ratio to provide different stages of extraction. The concentration ratio may progressively increase from a lowest concentration adjacent solvent inlet 20 to a highest concentration adjacent solvent or miscella outlet 22.

Solids material 16 processed in extractor 10 is conveyed out of solvent pool 24 and discharged through outlet 18 via a conveyor. In the configuration of FIG. 1, for instance, conveyor 26C conveys solids material 16 out of pool 24 towards discharge 18. Residual solvent retained by processed solids material 16 can drain under the force of gravity back into solvent pool 24. For this reason, the final bed deck or discharge deck 28 along which solids material 16 travels towards outlet 18 may be sloped upwardly away from solvent pool 24. Solvent carried with solids material 16 out of solvent pool may drain down the sloped bed deck back into the solvent pool, helping to minimize the amount of solvent carried out extractor 10 by the processed solids material being discharged from the extractor.

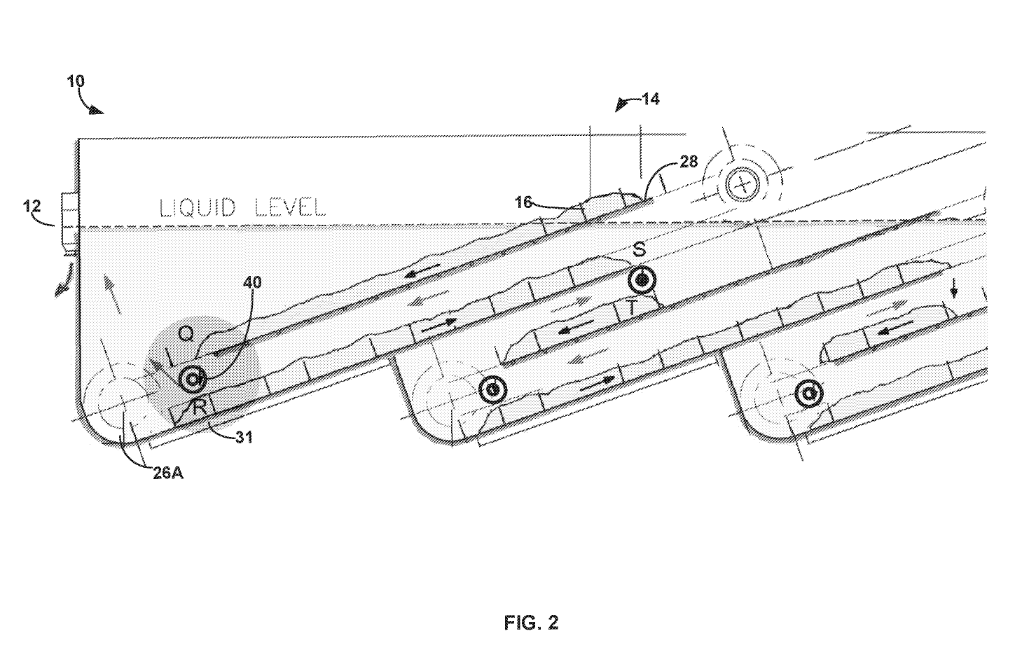

As mentioned previously in connection with FIG. 1, solids material 16 dropping off the discharge end 30B of an upper bed deck 28 can mix and interact with solvent located between the upper bed deck and a lower bed deck in drop zone 31, e.g., as the solids material falls under the force of gravity toward the lower bed deck. FIG. 2 is a partial side view of an example configuration of the extractor of FIG. 1 showing an example drop zone mixing hardware configuration. As shown in this example, extractor 10 includes mixing hardware 40 located at the drop zone 31 between an upper bed deck and a lower bed deck. Although each drop zone present in extractor 10 is illustrated as having mixing hardware 40, in practice, one or more drop zones (e.g., only one, two, three, or more) drops zones may be configured with mixing hardware 40.

Mixing hardware 40 may be any suitable mechanical device that promotes mixing between solids material 16 and solvent, e.g., as the solids material falls under the force of gravity from an upper bed deck to a lower bed deck. In some examples, mixing hardware 40 may a stationary or rotating cylinder having a rotation axis extending through the sidewalls of housing 12. For example, mixing hardware 40 may be an eccentric rotating cylinder having a rotation axis extending through the sidewalls of housing 12. As one such example, the eccentric rotating cylinder may be pipe with an oval cross-sectional shape. When a rotating element is used for mixing hardware 40, a rotational axis may positioned extending transversely (across the width) of housing 10 at an elevation between an upper bed deck and a lower bed deck.

In other examples, mixing hardware may have a more complex shape (e.g., impeller blades) that rotates to induce higher agitation and mixing. Mixing hardware 40 can be positioned within drop zone 40 between the upper bed deck and lower bed deck, e.g., such that falling solids material contacts the mixing hardware after falling off the terminal edge of the upper bed deck prior to reaching the lower bed deck. In different examples, mixing hardware 40 can be actively driven (e.g., by a motor located outside of housing 12) or passively driven. When implemented to be passively driven, the force of solids material and/or solvent flowing past the mixing hardware may be sufficient to interact with the hardware and cause mixing.

In other examples, mixing hardware 40 may not be positioned between the upper bed deck and the lower bed deck but may instead be a portion of the bed deck itself. For example, mixing hardware 40 may a shaped or profiled terminal edge of the upper bed deck that causes solids material dropping off the terminal edge intermix with solvent flowing in the opposite direction. The shaped or profiled terminal edge of the upper bed deck may cause solids material dropping off the terminal edge to drop non-uniformly into the solvent. For instance, rather than having a squared edge, the terminal edge of the upper bed deck may be flared, grooved, or otherwise contoured to cause intermixing between solids material flowing over and/or around the edge and surrounding solvent.

As yet another example, mixing hardware 40 may be implemented using a gas distribution header extending transversely across the housing. The gas distribution header can have one or more openings (e.g., a plurality of openings) through which gas is discharged into the solvent pool between the upper bed deck (from which solids material flows downwardly with respect to gravity) and the lower bed deck (from which solvent is traveling in a counter current direction). The gas injected into the solvent pool can create turbulence causing intermixing between the solids material and the solid. In different examples, the gas injected into the solvent pool may be steam, air, inert gas (e.g., nitrogen), or other gas. In applications where an organic solvent is used for extraction solvent, the injected gas may be substantially or completely devoid of oxygen to reduce the risk of creating a flammable environment.

Mixing hardware 40 may be useful to increase the surface area of solids material 16 exposed to solvent within drop zone 31, which may improve extraction yield. With respect to FIG. 2, for instance, as the bulk solids are conveyed down the slope of the upper bed deck and reach the end of the deck (e.g., shelf) designated Q, they may fall freely through liquid to the lower bed deck of conveyor 26A at R and proceed up the lower bed deck. As the solids material reach the top of that run at S, they again fall through liquid and reach the next lower bed deck at T. The vertical distance between end of an upper bed deck Q and the top surface of the lower bed deck R can vary based on a variety of factors, such as the size and capacity of the extractor. In some examples, the distance ranges from 0.1 meters to 2 meters, such as 0.5 meters to 1.5 meters.

In different examples, the mixing hardware 40 may be substantially centered along the vertical distance separating the upper bed deck from the lower bed deck or may be positioned closer to one bed deck (e.g., the upper bed deck or the lower bed deck) than the other bed deck. For example, positioning the mixing hardware 40 closer to the upper bed deck than the lower bed deck can provide a greater distance after mixing for the solids material to interact with surrounding solid and settle on the lower bed deck.

As the bed of solids material travels with the conveyor along each bed deck, the miscella in the bed gains oil and approaches equilibrium. At each drop zone 31 or fall between bed decks, mixing hardware 40 helps ensure that solids pass through the solvent as individual particles or in small clumps so that the near equilibrium (“high percent”) miscella is replaced with “lower percent miscella.” Some materials tend to agglomerate and not fall as small enough clumps to facilitate this process. Accordingly, mixing hardware 40 can help breakup these agglomerated materials to extraction efficiency. Thus, in some applications, mixing hardware 40 may impart mixing energy to solids material flowing off an upper bed deck effective to substantially uniformly mix the solids material with surrounding solvent and deagglomerate any agglomerated portions of the solids material.

Various examples have been described. These and other examples are within the scope of the following claims.

1. An immersion extractor comprising:
a housing configured to maintain a solvent pool in which a solids material being processed is immersed during operation of the extractor;
a plurality of bed decks positioned inside the housing, each of the plurality of bed decks providing a surface along which the solids material is conveyed during operation of the extractor; and
mixing hardware;
wherein at least one of the plurality of bed decks is positioned at a vertically elevated position relative to another of the plurality of bed decks so as to define a drop zone where the solids material drops from the vertically elevated bed deck to a lower bed deck, and
wherein the mixing hardware is configured to intermix the solids material with the solvent as solids material drops from the vertically elevated bed deck to the lower bed deck.

2. The immersion extractor of claim 1, wherein the mixing hardware comprises a rotating pipe.

3. The immersion extractor of claim 2, wherein the rotating pipe is eccentric.

4. The immersion extractor of claim 2, wherein the rotating pipe has an oval cross-sectional shape.

5. The immersion extractor of claim 2, further comprising a support axis extending transversely across the housing about which the rotating pipe is mounted.

6. The immersion extractor of claim 1, wherein the mixing hardware comprises a stationary pipe.

7. The immersion extractor of claim 1, wherein the mixing hardware comprises a gas distribution manifold.

8. The immersion extractor of claim 1, wherein the mixing hardware comprises a shaped edge of the vertically elevated bed deck.

9. The immersion extractor of claim 1, wherein the mixing hardware is configured to turbulently intermix the solids material with the solvent as solids material drops from the vertically elevated bed deck to the lower bed deck.

10. The immersion extractor of claim 1, wherein the mixing hardware is positioned within the drop zone between the vertically elevated bed deck and the lower bed deck.

11. The immersion extractor of claim 10, wherein the mixing hardware is positioned substantially centered in a vertical distance between the vertically elevated bed deck and the lower bed deck or closer along the vertical distance to the vertically elevated bed deck than the lower bed deck.

12. The immersion extractor of claim 11, wherein the vertical distance between the vertically elevated bed deck and the lower bed deck ranges from 0.5 meters to 1.5 meters.

13. A method comprising:
conveying solids material to be processed through a solvent pool of an immersion extractor, wherein conveying the solids material through the solvent pool comprises conveying the solids material along a plurality of bed decks that include at least one bed deck positioned at a vertically elevated position relative to another bed deck that defines a lower bed deck, and
mixing solids material flowing from the vertically elevated bed deck toward the lower bed deck using mixing hardware.

14. The method of claim 13, wherein mixing solids material comprises passing solids material falling from the vertically elevated bed deck toward the lower bed deck over at least one of a rotating and a stationary pipe extending transversely across the immersion extractor.

15. The method of claim 14, wherein the mixing hardware is a rotating pipe having one of an eccentric cross-sectional shape and an oval cross-sectional shape.

16. The method of claim 13, wherein mixing solids material comprises passing solids material over a shaped edge of the vertically elevated bed deck that causes mixing.

17. The method of claim 13, wherein mixing solids material comprises injecting gas into a space between the vertically elevated bed deck and the lower bed deck.

18. The method of claim 13, wherein mixing solids material comprises mixing the solids material an amount effective to turbulently intermix the solids material with the solvent as solids material drops from the vertically elevated bed deck to the lower bed deck.

19. The method of claim 13, wherein the mixing hardware is positioned substantially centered in a vertical distance between the vertically elevated bed deck and the lower bed deck or closer along the vertical distance to the vertically elevated bed deck than the lower bed deck.

20. The method of claim 19, wherein the vertical distance between the vertically elevated bed deck and the lower bed deck ranges from 0.5 meters to 1.5 meters.
